(19) United States
(12) Patent Application Publication
(10) Pub. No.: US 2024/0190220 A1
(43) Pub. Date: Jun. 13, 2024

(54) Airborne Object Deflection System

(71) Applicant: Invention Licensing, Tucson, AZ (US)

(72) Inventor: Timothy Basta, Tucson, AZ (US)

(73) Assignee: Invention Licensing, Tucson, AZ (US)

(21) Appl. No.: 18/534,889

(22) Filed: Dec. 11, 2023

Related U.S. Application Data
(60) Provisional application No. 63/387,128, filed on Dec. 13, 2022.

(51) Int. Cl. B60J 1/20; B60W 50/00

(52) U.S. Cl. CPC B60J 1/2094; B60W 50/0097; B60W 2420/42

(57) ABSTRACT

A system includes a deflector and an imaging system configured to be coupled to a vehicle. The deflector may be a windshield wiper with a pad coupled to a side opposite the wiper blade. The imaging system includes an objection detection camera. The deflector is configured to move across a predetermined portion of the windshield of the vehicle. A control system is configured to receive image data from the imaging system while the vehicle is in motion. Further, the control system is configured to identify an airborne object in a field of vision of the imaging system. Based on the receiving image data and identified airborne object, a trajectory of the airborne object is determined, and the deflector is operated to contact the airborne object.

### BACKGROUND

The automotive industry has gone through various transformations over the years. Most recently, vehicle technology has advanced with the onset of electric vehicles, autonomous driving, advanced computer systems, and artificial intelligence becoming standard within the industry. However, while certain aspects of transportation vehicle technology have advanced, other features remain largely the same.

For example, while the windshield has been the subject of certain advancements, such as the use of safety laminated glass or automatic windshield wipers that detect water or other debris on the surface of a windshield, the basic feature of the windshield being a large piece of transparent glass that is designed to protect and provide comfort to vehicle occupants is unchanged. The nature of the windshield being a large piece of glass on the front of a vehicle that is necessarily exposed to wind, rain, snow, ice, debris, and other unpredictable conditions unfortunately means that there is risk for the windshield to suffer damage. In fact, approximately thirteen million car windshields are replaced each year, at significant cost to consumers, manufacturers, and insurance companies, among others. Damaged windshields are also an important safety concern as cracked windshields may be weakened and offer less protection to occupants, as well as cause visibility issues for vehicle operators.

While certain passive systems, such as advances in material science, additional protective layers, and other similar concepts have entered the market, there remains a need for a better system specifically designed to protect vehicle windshields from becoming damaged.

### SUMMARY

Aspects of the systems, devices, and methods described herein address the lack of systems designed to actively protect windshields. More particularly, systems utilizing one or more deflectors, which may generally be windshield wipers fitted with impact absorbent pads, along with an object detection camera configured to identify and track airborne objects or debris such as rocks or other small flying objects are described. The systems, devices, and methods disclosed intercept airborne or bouncing or flying debris using the deflectors before the debris contacts the windshield potentially causing damage.

In one aspect, a system is disclosed. The system includes a deflector and an imaging system configured to be coupled to a vehicle, such as a car, train, plane, or boat. The deflector is configured to move across a windshield of the vehicle, and more particularly, a predetermined or known portion of the windshield. In some examples, the deflector may have a pad, and more specifically an impact absorbent pad coupled to and outer facing side of the deflector. In some embodiments, the deflector may also be a windshield wiper with a wiper blade installed on an opposite side from the pad. The wiper blade is configured to contact the windshield while the wiper moves across at least a portion of the windshield.

The system includes a control system, for example in the form of a computer device included as part of the vehicle, and the control system is configured to carry out various tasks. For example, the control system receives image data from the imaging system while the vehicle is in motion. The control system also identifies an airborne object in a field of vision of the imaging system based on the receive image data. Further, the control system is configured to determine a trajectory of the airborne object based on the received image data as well as the identified airborne object. The control system also operates the deflector to locate the deflector in a position to contact the airborne object based on the determined trajectory. In some examples, the deflector contacts (or, e.g., deflects or intercepts) the airborne object thereby preventing the object from contact the windshield directly. Instead, the force of the airborne object is absorbed and spread across the deflector, including in some examples a deflector pad, such that the potential for damage is reduced.

In another aspect, a method is disclosed. The method involves receiving image data from an object detection camera coupled to a vehicle. The method also includes identifying an airborne object in a field of vision of the object detection camera based on the received image data. The object detection camera may be mounted or otherwise coupled to the vehicle such that a field of vision of the object detection camera extends forward away from the windshield far enough of a distance such that it can identify the airborne object. In some examples the object detection camera may identify one or more airborne objects that are on a path or course for contacting or colliding with the windshield. Continuing, the method involves determining a trajectory of the airborne object based on the collected image data.

The method further includes determining that the airborne object has potential to damage a windshield coupled to the vehicle if the airborne object were to contact the windshield. This determination is based on the collected image data and the determined trajectory. Based on the determination that the airborne object has potential to damage the windshield, the method also includes moving a deflector from a current position to an intercept position. When in the intercept position the deflector is positioned to contact the airborne object.

In yet another aspect, a non-transitory computer-readable medium is disclosed. The medium has stored thereon program instructions that when executed by a processor cause performance of the acts of the methods described above. In another aspect, a computing device is disclosed. The computing device includes a communication interface, a processor, and a non-transitory computer-readable medium having stored thereon program instructions that when executed by the processor cause the computing device to perform the acts of the methods described above.

In a further aspect, a vehicle is disclosed. The vehicle includes a windshield, an object detection camera, and a windshield wiper. The object detection camera is configured to identify and track a trajectory of an airborne object. The windshield wiper includes a wiper blade configured to wipe a predetermined section of the windshield. Moreover, the windshield wiper includes a deflection pad on a side opposite the wiper blade. The deflection pad may be configured to absorb at least a portion of the impact of the airborne object. The windshield wiper is configured to operate in at least a wiping mode and a deflection mode. When in the wiping mode, the windshield wiper rotates about an axis such that the wiper blade moves across the predetermined section of the windshield. For example, when in the wiping mode, the wiper blade may push and/or remove water (such as from rain) from the windshield surface. When in the deflection mode, the windshield wiper rotates about the axis such that the windshield wiper is positioned such that the airborne object contacts the deflection pad.

In some embodiments of the vehicle disclosed, a second windshield wiper with second wiper blade and second deflection pad is described. A computing device, including, e.g., a control system, object detection camera, and/or an imaging system (or a combination thereof), may control the operation of the one or more windshield wipers. Relatedly, various control schemes are considered within the scope of the disclosure herein. For example, the computing device may determine to operate on windshield wiper deflector to attempt to contact an airborne object, but not operate a second windshield wiper deflector, based on, for example, the section of the windshield that the object is expected to impact. In another example, another exemplary control scheme is disclosed. The vehicle is traveling through rain such that a pair of windshield wipers with deflector pads are operating to maintain visibility through the windshield. The computing device (or set of computing devices) may determine that an airborne object with the potential to damage the windshield is traveling towards the windshield, but only determine to operate the passenger side windshield wiper in deflection mode, while maintaining the driver side windshield wiper in a wiping mode in order to maintain some minimum visibility while also attempting to protect the windshield from other damage. In some instances, such a scheme may be dependent upon other variables such as the intensity of the rain on the windshield. Other control schemes, including other independent operation of one or more deflectors, is contemplated within this disclosure.

These, as well as other aspects, advantages, and alternatives, will become apparent to those of ordinary skill in the art by reading the following detailed description, with reference where appropriate to the accompanying drawings.

### BRIEF DESCRIPTION OF THE FIGURES

FIG. 1 is an illustration of a vehicle with an airborne object deflection system, according to an example embodiment.

FIG. 2A is an illustration of the vehicle a deflector of the airborne object deflection system in a stored position.

FIG. 2B is an illustration of the vehicle a deflector of the airborne object deflection system in an intercept position.

FIG. 3 is a flow chart depicting acts of an example method.

### DETAILED DESCRIPTION

### I. Overview

Windshields are a critical component to transportation vehicles, including cars, trucks, airplanes, trains, boats, etc. Vehicles are designed to travel through the environment around them, and generally protect the occupants of the vehicle from outside elements. Particularly, windshields protect occupants, including operators, from outside elements such as wind, precipitation, and debris that may be in a travel path through a given environment, such as a road, water, air. In order to be effective, windshields must be strong enough to withstand contact with wind, precipitation, debris, etc. As such, windshields are generally constructed from laminated glass that is designed to withstand a certain amount of force and impact in order to effectively protect the occupants. However, despite being designed to withstand a certain amount of impact, windshields experience damage such as cracking and chipping from being contacted by objects, such as rocks and other hard debris. Commonly, such debris is kicked up by tires of other vehicles, or similar situations. Damaged windshields risk failure and potential unsafe conditions for an occupant, such as operating a vehicle in which the windshield obstructs clear viewing or operation. In certain circumstances, damaged windshields may cause further failure of the windshield resulting in the windshield failing to protect the occupants, or even becoming a danger to the occupants.

The airborne object deflection system is an active system, generally implemented as a component of a vehicle or vehicle system. In some regards, the airborne detection system may be considered an active system configured to deflect an airborne object before the object contacts a windshield. In one embodiment, the airborne object deflection system may include at least one windshield wiper and an object detection camera in communication with the at least one windshield wiper. The object detection camera may identify and track an airborne object that has a trajectory vector such that the object is likely to impact the windshield. Based on the trajectory of the object relative the vehicle, a position or location on the windshield that the object is likely to impact may be determined, and utilizing the geometry of the windshield wiper, the system may operate the windshield wiper to intercept and attempt to deflect the object before the object contacts the windshield. In some examples, the wiper may include a pad, or particularly an impact absorbent pad.

### II. Example System

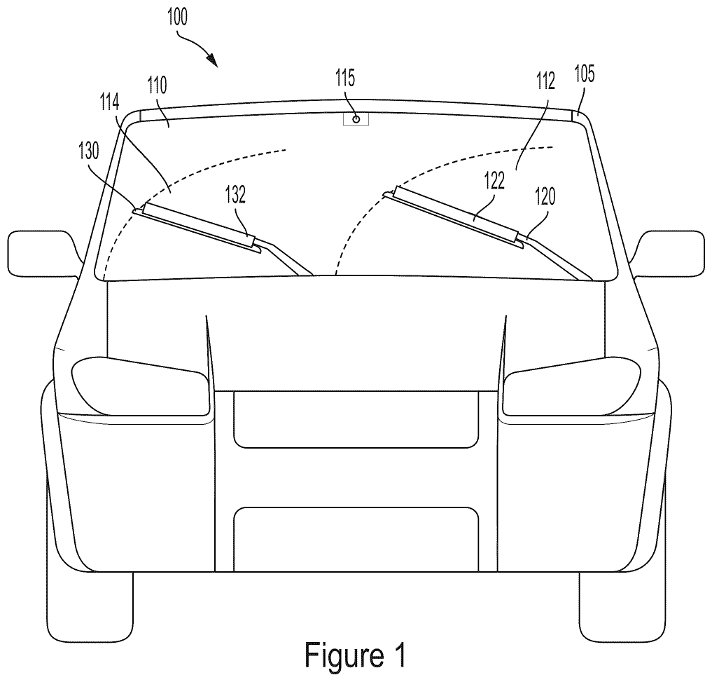

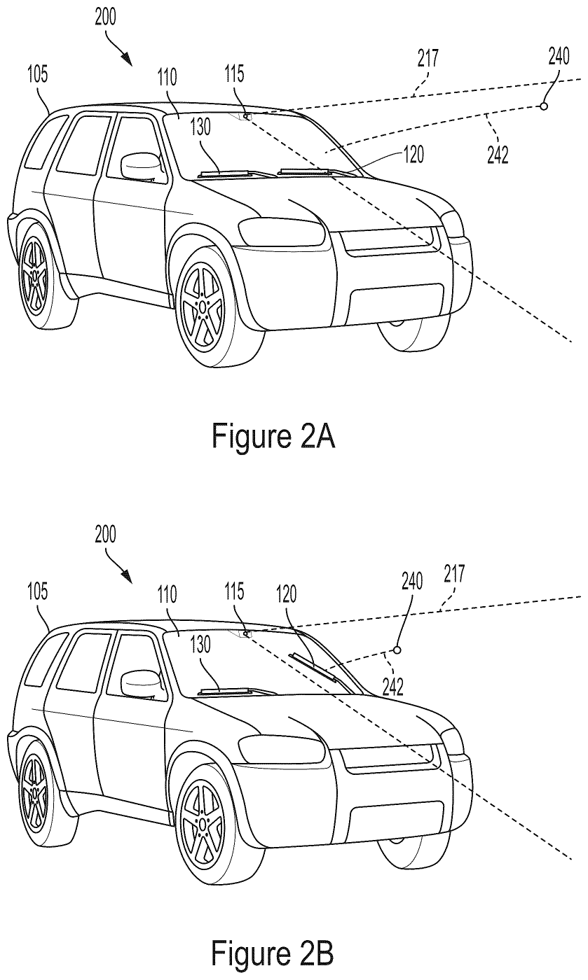

FIG. 1 depicts an airborne object detection system 100 implemented on a car 105. It should be understood that while FIG. 1 (and FIGS. 2A-2B below) depicts the airborne object detection system 100 on the car 105, the airborne object detection system 100 may be implemented on other vehicles with windshields, such as on trucks planes, trains, and boats, for example. The car 105 includes a windshield 110. The windshield 110 may be visually transparent and generally maintain aspects of the outside environment outside the interior of the car 105. The windshield 110 may generally be configured on the front of the car 105. The windshield 110 has a first section 112 and a second section 114. In other examples, the windshield 110 may only have one section, or may have more than two sections. As illustrated, the first section 112 may correspond to a driver or operator side visibility section of the windshield 110, while the second section 114 may correspond to a passenger side visibility section of the windshield 110.

The car 105 further has an object detection camera 115. The object detection camera 115 may have a field of view that extends out from the object detection camera 115. The object detection camera 115 is coupled to a front of the car 105 such that the field of view of the car 105 is in a forward direction. In some examples, the object detection camera 115 may be located near, within, or part of a rear-view mirror assembly. In other examples, the object detection camera 115 may be located on or near the hood of the car 105. In yet another example, the object detection camera 115 is located anywhere on the car 105 or other vehicle such that the field of view of the object detection camera 115 expands out such that any object that may contact the windshield 110 would enter the field of the view of the object detection camera 115. The object detection camera 115 may be configured to identify and track a trajectory of an airborne object that appears within the field of view of the object detection camera 115.

In some examples, the object detection camera 115 may be at least a component of an imaging system, where the imaging system may be part of the car 105. In other examples, the object detection camera 115 may be considered an imaging system. The imaging system may be coupled to, or part of a control system that is part of the car 105. While the imaging system and control system are part of the airborne object detection system 100, in some examples the imaging system and/or the control system may be part of the car 105, while in other examples at least some aspect of the imaging system and/or the control system may be located remote from the car 105. For example, the control system may be part of a computing device that is physically separate from the car, or cloud computing device or system. In yet other examples, the imaging system and the control system may be considered part of the object detection camera 115.

The car 105 further includes a first deflector 120 and a second deflector 130. The first deflector 120 may include a first deflector pad 122. The first deflector 120 may correspond to a section on the windshield 110, for example, as illustrated in FIG. 1, the first deflector 120 corresponds to the first section 112. The first deflector pad 122 is coupled to an outer side of the first deflector 120. The first deflector pad 122 may be configured to contact an airborne object. In some examples, the first deflector 120 may include a deflector arm and the first deflector pad 122 may be coupled to the deflector arm.

The first deflector pad 122 may extend along at least a portion of the first deflector 120 or in some examples, extend along at least a portion of a deflector arm that is part of the first deflector 120. The first deflector pad 122 may be constructed from a material configured to absorb some of the force from an object that may otherwise impact the windshield 110. For example, the first deflector pad 122 may be constructed from a low durometer silicone rubber, among other possibly materials with similar characteristics that would be known to those skilled in the art. In some regards, an outer side of the first deflector 120 may be constructed from low durometer silicone rubber, for example.

The first deflector 120 may be configured to rotate about an axis such that the first deflector 120 moves across the first section 112 of the windshield 110. The axis of rotation may be at a proximate end of the first deflector 120, such as near or just below a bottom end of the windshield 110. In some examples, a first deflector arm of the first deflector 120 may be configured to rotate about an axis such that the first deflector 120 moves across the first section 112 of the windshield 110. The first deflector 120 may be configured to move to an intercept position, described more below, wherein the intercept position is an angle of the first deflector 120 (or component thereof), relative to a storage position, a horizontal, or some other reference position.

In some examples, the first deflector 120 may include a first windshield wiper where the wiper is in contact with the windshield 110. The first windshield wiper may be coupled to an inner side of the first deflector 120, or may be coupled to an inner side of a deflector arm that is part of the first deflector 120.

The second deflector 130 may include a second deflector pad 132. The second deflector 130 may correspond to a section on the windshield 110, for example, as illustrated in FIG. 1, the second deflector 130 corresponds to the second section 114. The second deflector pad 132 is coupled to an outer side of the second deflector 130. The second deflector pad 132 may be configured to contact an airborne object. In some examples, the second deflector 130 may include a deflector arm and the second deflector pad 132 may be coupled to the deflector arm.

The second deflector pad 132 may extend along at least a portion of the second deflector 130 or in some examples, extend along at least a portion of a deflector arm that is part of the second deflector 130. The second deflector pad 132 may be constructed from a material configured to absorb some of the force from an object that may otherwise impact the windshield 110. For example, the second deflector pad 132 may be constructed from a low durometer silicone rubber, among other possibly materials with similar characteristics that would be known to those skilled in the art. In some regards, an outer side of the second deflector 130 may be constructed from low durometer silicone rubber, for example.

The second deflector 130 may be configured to rotate about an axis such that the second deflector 130 moves across the second section 114 of the windshield 110. In some examples, a second deflector arm of the second deflector 130 may be configured to rotate about an axis such that the second deflector 130 moves across the second section 114 of the windshield 110. The second deflector 130 may be configured to move to an intercept position, described more below, wherein the intercept position is an angle of the second deflector 130 (or component thereof), relative to a storage position, a horizontal, or some other reference position.

In some examples, the second deflector 130 may include a second windshield wiper where the wiper is in contact with the windshield 110. The second windshield wiper may be coupled to an inner side of the second deflector 130, or may be coupled to an inner side of a deflector arm that is part of the second deflector 130.

As provided in more detail below, in some uses the first deflector 120 may operate in sync or together with the second deflector 130, while in other uses the first deflector 120 and the second deflector 130 may operate independently from one another. Moreover, the first and second deflectors 120 and 130 may also be considered windshield wipers and may have more than one function on the car 105. For example, a user may operate the deflectors 120 and 130 in a wiping mode, using wiper blades attached to the deflectors 120 and 130 to move water or other liquid from the windshield 110 as the deflectors 120 and 130 move across the windshield 110. In other examples, a computer system may operate the deflectors 120 and 130 in a wiping mode. The computer system may include one or more sensors, and cameras design to detect precipitation or liquid, and the object detection camera 115 may be a component of such a computer system.

FIG. 2A and FIG. 2B illustrate an airborne object detection system 200 that may similar or the same as the airborne object detection system 100 from FIG. 1. For example, FIGS. 2A and 2B depict the car 105 which has windshield 110, object detection camera 115, the first deflector 120, and the second deflector 130. Each of the windshield 110, object detection camera 115, the first deflector 120, and the second deflector 130 may have the features and characteristics as those similarly described in relation to FIG. 1. Moreover, other aspects of the windshield 110, object detection camera 115, the first deflector 120, and the second deflector 130 would be apparent to those skilled in the art in view of the illustration provided as FIGS. 2A and 2B.

In FIG. 2A, the car 105 may be in motion, and more particularly, traveling forward down a roadway. The first deflector 120 and the second deflector 130 may be considered in a stored position as depicted in FIG. 2A. While the car 105 is in motion, an imaging system, which is coupled to the vehicle, may provide image data to a control system. The control system may be part of the imaging system, or in other configurations the imaging system may be part of the control system. Similarly, it should be appreciated that either one of the imaging system or the control system, or both, may be part of or in electrical communication with the object detection camera 115. The image data may include a video feed of a field of view 217 of the object detection camera 115.

In other examples, the image data may include radar, LiDAR, sonar, or other known object tracking data. Relatedly, while a single object detection camera 115 is described, it should be appreciated that more than one camera or related image sensing system may be used and still be considered within the scope of this disclosure. For example, two object detection cameras may be used, and may be connected or part of a computer system which may include the control system and/or the imaging system described herein.

As such, the imaging system, and/or the control system, included in the airborne object detection system 200 may include any known object detection or sensing device or system that can be configured to accomplish the functions and tasks described herein. Similarly, it should be appreciated that the airborne object detection system 200 may be configured with multiple object sensing sensors, cameras, or similar and be able to sense more than one airborne object at a given time.

While generally described as being activated while the car 105 is in motion, it should be appreciated that other implementations are possible without departing from the scope of this disclosure. For example, if the car 105 is parked, but the airborne object detection system 200 remains active, the airborne object detection system 200 may still operate as described herein.

FIGS. 2A and 2B depict an airborne object 240 that has entered the field of view 217 of the object detection camera 115. As such, image data from the imaging system may include data related to the airborne object 240. The control system may identify the airborne object 240 based on the image data received from the imaging system. For example, the control system may identify the airborne object 240 as an object that may cause damage, or has the potential to cause damage, to the windshield 110 if the airborne object 240. For example, the control system may identify the airborne object 240 as a rock that may cause a crack or chip in the windshield 110. The control system may also identify the airborne object 240 as an object that would not cause damage to the windshield 110, such as a leaf or something with a low enough mass that the object does not require deflection or interception by the airborne object detection system 200 or a component thereof. In some aspects, some level of machine learning may be utilized by at least one of the imaging system, the control system, or the object detection camera 115 in order to identify the airborne object 240 as an object that may result in damage to the windshield 110 if the airborne object 240 were to contact the windshield 110.

In some examples, the control system may determine a size of the airborne object 240 as part of identifying whether the airborne object 240 may cause damage to the windshield 110. The potential to cause damage to the windshield 110 may be based on physical characteristics of the airborne object 240. The physical characteristics of the airborne object 240 may be interpreted, calculated, or otherwise determined by the control system, imaging system, object detection camera 115, or a combination thereof. It should be appreciated that the airborne object 240 may be any object that enters the field of view 217 of the object detection camera 115. For example, the airborne object 240 may be a rock, stick, pebble, or other piece of debris that has entered the field of view 217. In some examples, the object detection camera 115 may be configured to identify objects greater than a certain size, such as greater than 10 millimeters. In other instances, the object detection camera 115 may be configured to identify objects greater 4 millimeters.

As illustrated in FIGS. 2A and 2B, the airborne object 240 may have a trajectory 242. The trajectory 242 of the airborne object 240 may be relative to the motion of the car 105, and be determined by the control system based on at least the image data received from the imaging system and data related to the identified airborne object. In some aspects, the object detection camera 115, in conjunction with the control system (of which the object detection camera 115 may be a component), may be considered to “track” the airborne object 240. In some regards, the control system may calculate or determine a trajectory vector for the airborne object 242.

Based on the relative trajectory 242 of the airborne object 240, the control system may determine that the airborne object 240 is likely to contact the car 105. More particularly, the control system may determine that airborne object 240 may contact the windshield 110. Even more particularly, the control system may determine that the airborne object 240 may contact a specific section of the windshield 110. For example, the control system may determine that the trajectory 242 of the airborne object 240 may be such that the airborne object 240 will contact a first section (such as the first section 112) of the windshield, or a driver section of the windshield. Thus, the control system may determine that the first deflector 120, which corresponds to the first section (such as the first section 112) must be activated or operated in a deflection mode.

In preferred embodiments, the control system is able to determine that the airborne object 240 will likely contact a specific location on the windshield 110. In other aspects, it may be that the control system is able to predict a likely impact position of the airborne object 240 on the windshield 110. The impact position may be within an identified section of the windshield 110.

Continuing with the embodiment depicted in FIG. 2B, having identified and determined a trajectory 242 of the airborne object 240, the control system may operate the first deflector 120 such that the first deflector is in a position to contact the airborne object 240. In some regards, the first deflector 120 may be in an intercept position in FIG. 2B. The intercept position may be defined by an angle of the first deflector 120 relative to a predetermined or known position such that an aspect along the length of the first deflector 120 is between the airborne object and the location on the windshield 110 where the airborne object 240 would contact but for the deflector 120 being in the intercept position. When in the intercept position, the first deflector 120 may contact, absorb, and/or deflect the airborne object 240 such that the airborne object 240 does not contact the windshield 110. In some examples, a pad, such as the first pad 122, of the first deflector 120 is what contacts the airborne object 240 when the deflector reaches the intercept position.

After contacting the airborne object 240, the first deflector 120 may return to the stored position. As shown in FIG. 2B, the second deflector 130 may remain in the stored position. For example, the control system may have determined that only the first deflector needs to be operated in order to deflect the airborne object 240.

The deflectors 120 and 130 may have more than one operating mode, that may be controlled by the control system. In some embodiments, the deflectors 120 and 130 may be operating in a wiper mode. For example, the deflectors 120 and 130 may have wiper blades coupled to inner sides thereof, and the car 105 may be traveling through rain. In some embodiments the deflectors 120 and 130 may be configured to interrupt one operation mode to enter a deflection mode. When in the deflection mode, one or both of the deflectors 120 and 130 may be operated to a specific location on the windshield 110 in an attempt to intercept the airborne object 240.

In some examples, the control system may be configured to make a determination that based on the severity or intensity of the rain, at least one of the deflectors should remain in the wiping mode no matter if an airborne object enters the filed of vision of the object detection camera. In other example, the control system may allow the passenger side deflector to operate in a deflection mode, even if the deflectors are otherwise operating in a wiper mode. In other words, the control system may determine that based on the severity of the rain, the passenger side deflector is acceptable to operate in a deflection mode, but in order to safely operate the vehicle the driver side deflector should continue to operate in the wiper mode, even if an airborne object is likely to impact the driver side section of the windshield.

It should be appreciated that, while FIGS. 1, 2A, and 2B depict multiple deflectors on a single windshield, in other environments and implementations, only a single deflector may be located on a windshield. Or relatedly, multiple windshields may exist on a single vehicle, and each windshield may have at least one deflector. In such an example, there may be one centralized control system, with one or more object detection sensors in communication with the control system.

### III Example Operations

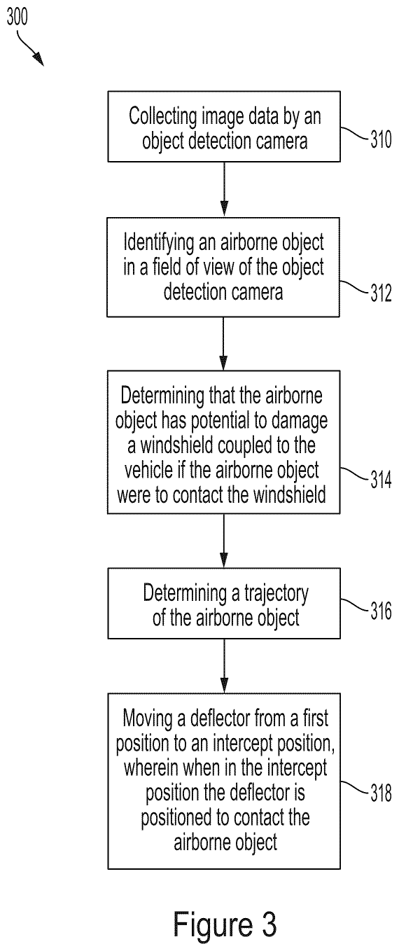

FIG. 3 is a flow chart depicting functions or actions that can be carried out in an example method 300 for operating a deflector to intercept an airborne object before the object contacts a windshield of a vehicle. The method 300 may be implemented as part of a vehicle system, which may include an airborne object detection system. The airborne object detection system may communicate with or include one or more other systems, such as a control system of the vehicle. In some examples, the method 300 may be implemented using aspects of a vehicle that are well-known, such as windshield wipers, camera systems, and/or object sensors.

Block 310 describes collecting image data by an object detection camera. The object detection camera may include one or more object sensors that are positioned in relation to, including as part of, the vehicle such that the object detection camera is able to sense an object external to the vehicle itself that may contact the vehicle, potentially causing damage to the vehicle. The object detection camera may regularly collect image data while the vehicle is in motion, for example. In other example, the object detection camera may collect data anytime the vehicle is powered on.

The object detection camera may include, be part of, or communicate with a control system. The control system may be, or maybe in communication with a computing device that includes a communication interface, a processor, and a non-transitory computer-readable medium having stored thereon program instructions that when executed by the processor cause the computing device to perform the acts of the methods described herein. The control system may further include, be part of, or communicate with an imaging system, which may include the object detection camera.

At block 312 the method includes identifying an airborne object in a field of view of the object detection camera. Identifying the airborne object in the field of view may include sensing that that the airborne object is in front of the vehicle and more particularly the vehicle windshield.

At block 314 the method describes determining that that airborne object has the potential to damage the windshield of the vehicle if the airborne object were to contact the windshield. Determining whether an object as the potential to damage the windshield may include identifying, determining, and/or calculating physical characteristics about the object based on the image data.

At block 316 the method describes determining a trajectory, which may be considered a relative trajectory or a trajectory vector, of the airborne object. A computing device, such as the control system described herein, may calculate the trajectory and predict a potential location of impact on the windshield.

At block 318 the method describes moving a deflector from a first position to an intercept position. The first position may be considered a current position, or a position at a given time point, for example. At the intercept position the deflector is positioned to contact the airborne object. In some examples, moving the deflector may include rotating the deflector such that deflector intersects or overlaps with the potential location of impact of the airborne object on the windshield. In this position, the deflector, which may include a component such as an impact absorbing pad, may contact the airborne object, thereby preventing the object from contacting the windshield.

The method may further include other steps, such as, determining which deflector of a plurality of deflectors to move or operate to the intercept position. Other methods are also within the scope of this disclosure.

For example, another example method may include operating a plurality of windshield wipers configured with impact pads to potentially deflect an airborne object. The method may further include, based on determining that an airborne object will likely contact the windshield, operating at least one of the plurality of windshield wipers in a deflection mode. The windshield wipers may be configured to operate in other modes as well, such as a wiper mode.

A control system connected to the windshield wipers may be configured to make determinations about what mode(s) to operate each of the windshield wipers. For example, a control system may determine a risk potential of an airborne object and compare that risk against other existing environmental conditions (such as rain or precipitation) and make a determination regarding whether to change operation mode(s) of one or more of the windshield wipers, for example.

While certain operations and control schemes have been described herein, it would be apparent that other, similar operations and schemes are possible and within the scope of this disclosure.

### IV. Example Variations

The variations described in connection with select examples of the disclosed systems, devices, and methods may be applied to all other examples of the disclosed systems, devices, and methods. For example, various examples are described in terms of a car, but may also be applicable to other vehicles such as an airplane. These and similar iterations would be apparent to a person of skill in the art.

Further, while one or more functions have been described as being performed by or otherwise related to certain devices or entities, the functions may be performed by or otherwise related to any device or entity. As such, any function that has been described as being performed by the imaging system could alternatively be performed by a different device such as the object detection camera. Further, the functions need not be performed in the disclosed order, although in some examples, an order may be preferred. Also, not all functions need to be performed to achieve the desired advantages of the disclosed systems, devices, and methods, and therefore not all functions are required.

While select examples of the disclosed systems and methods have been described, alterations and permutations of these examples will be apparent to those of ordinary skill in the art. Other changes, substitutions, and alterations are also possible without departing from the disclosed systems, devices, and methods in broader aspects as set forth in the following claims.

What is claimed is:

1. A system comprising:
a deflector configured to be coupled to a vehicle, wherein the deflector is configured to move across a predetermined portion of a windshield coupled to the vehicle;
an imaging system configured to be coupled to the vehicle; and
a control system configured to:
while the vehicle is in motion, receive image data from the imaging system;
identify, based on the received image data, an airborne object in a field of vision of the imaging system;
determine, based on the received image data and identified airborne object, a trajectory of the airborne object; and
operate the deflector, based on the determined trajectory, to locate the deflector in a position to contact the airborne object.

2. The system of claim 1, wherein the deflector comprises:
a pad coupled to an outer side of the deflector, wherein the pad is configured to contact the airborne object.

3. The system of claim 2, wherein an inner side of the deflector comprises a wiper blade that is in contact with the windshield when the deflector moves across the windshield.

4. The system of claim 2, wherein the pad extends along a portion of the deflector.

5. The system of claim 1, wherein the deflector comprises a deflector arm configured to rotate about an axis.

6. The system of claim 1, wherein an outer side of the deflector comprises a low durometer silicone rubber.

7. The system of claim 1, further comprising a second deflector configured to be coupled to the vehicle, wherein the second deflector is configured to move across a second predetermined portion of the windshield.

8. The system of claim 7, wherein the control system is further configured to:
determine, based on the trajectory of the airborne object, which of the deflector or the second deflector to operate.

9. The system of claim 1, wherein the control system is further configured to:
determine, based on the determined trajectory, that the airborne object has potential to damage the predetermined portion of the windshield.

10. The system of claim 9, wherein determining that the airborne object has potential to damage the predetermined portion of the windshield is based on a relative speed of the airborne object.

11. The system of claim 1, wherein the control system is further configured to:
determine, based on the received image data and identified airborne object, that the airborne object has potential to damage the windshield if the airborne object contacts the windshield.

12. The system of claim 11, wherein determining that the airborne object may damage the windshield is based on a size of the airborne object.

13. The system of claim 1, wherein the imaging system comprises an object detection camera configured to be coupled to the vehicle such that the object detection camera faces a forward vehicle direction.

14. A method comprising:
collecting, by an object detection camera coupled to a vehicle, image data;
identifying, based on the collected image data, an airborne object in a field of vision of the object detection camera;
determining, based on the collected image data, a trajectory of the airborne object;
determining, based on the collected image data and the determined trajectory, that the airborne object has potential to damage a windshield coupled to the vehicle if the airborne object were to contact the windshield; and
moving, based on the determination that the airborne object has potential to damage the windshield, a deflector from a first position to an intercept position, wherein when in the intercept position the deflector is positioned to contact the airborne object.

15. The method of claim 14, wherein the deflector has a wiper blade on an inner side configured to contact the windshield and a pad on an outer side configured to contact the airborne object.

16. The method of claim 15, further comprising:
determining, based on the trajectory, which deflector of a plurality of deflectors to move from the first position to the intercept position.

17. The method of claim 16, wherein the deflector is a deflector arm configured to rotate about an axis, wherein the axis is located at a proximate end of the deflector arm, and the intercept position is an angle of the deflector arm relative to a storage position.

18. A vehicle comprising:
a windshield coupled to the vehicle;
an object detection camera coupled to the vehicle, wherein the object detection camera is configured to identify and track a trajectory of an airborne object; and
a windshield wiper comprising:
a wiper blade configured to wipe a predetermined section of the windshield; and
a deflection pad on a side opposite the wiper blade;
wherein the windshield wiper is configured to operate in at least a wiping mode and a deflection mode;
wherein when in the wiping mode, the windshield wiper rotates about an axis such that the wiper blade moves across the predetermined section of the windshield; and
wherein when in the deflection mode, the windshield wiper rotates about the axis such that the windshield wiper is positioned for the deflection pad to contact the airborne object.

19. The vehicle of claim 18, further comprising:
a second windshield wiper comprising:
a second wiper blade configured to wipe a second predetermined section of the windshield; and
a second deflection pad on a side opposite the second wiper blade;
wherein the second windshield wiper is also configured to operate at least the wiping mode and the deflection mode;
wherein when in the deflection mode, the second windshield wiper rotates about the axis such that the second windshield wiper is positioned for the second deflection pad to contact the airborne object.
wherein the object detection camera determines, based on the trajectory, which of the windshield wiper or the second windshield wiper to operate in the deflection mode.

20. The vehicle of claim 19, wherein the windshield wiper cannot operate in the deflection mode if already in the wiping mode, but wherein the second windshield wiper can operate in the deflection mode if already in the wiping mode if the object detection camera determines that the trajectory of the airborne object is such that it would contact the second predetermined section of the windshield.
